(19) United States
(12) Patent Application Publication
(10) Pub. No.: US 2004/0044762 A1
(43) Pub. Date: Mar. 4, 2004

(54) Methods and apparatus for controlling internet protocol traffic in a wan or lan

(76) Inventor: Kimberly Roseanne Peacock, Fresh Meadows, NY (US)

Correspondence Address: David P Gordon, Gordon & Jacobson, 65 Woods End Road, Stamford, CT, 06905, US

(21) Appl. No.: 10/220,221

(22) PCT Filed: Feb. 22, 2001
(86) PCT No.: PCT/US01/05690

(51) Int. Cl. G06F 15/173

(52) U.S. Cl. 709/224

(57) ABSTRACT

Methods and apparatus for controlling traffic in a communications network (FIG. 5) include providing a plurality of local active nodes and a master node wherein the local active nodes poll network equipment associated with them and transmit information about network utilization to the master active node. Periodically the master active node transmits network status information to the local active nodes. The local active nodes may also query the master active node about network status. Hosts coupled to a local active node query the node for network status.

This application claims the benefit of provisional application Ser. No. 60/184,758, filed Feb. 23, 2000, the complete disclosure of which is hereby incorporated by reference herein.

### BACKGROUND OF THE INVENTION

1. Field of the Invention

The invention relates to telecommunications networks which utilize Internet Protocol (IP). More particularly, the invention relates to methods and apparatus for controlling the transfer of IP packets over a network.

2. State of the Art

The state of the art is represented by the following documents which are abstracted below and which are attached in their entirety to the above referenced provisional application and made a part of this disclosure:

Murphy, David M., Building an Active Node on the Internet MIT, May 1997.

“An Active IP Network integrates two very different network programming models, an IP packet based model, and an Active Network capsule based model. This report shows how to integrate these two models into a single node, called an Active IP node, and how to integrate an Active IP node into an IP network. It also presents some preliminary ideas on the constraints network architects will face when building Active protocols for a heterogeneous network of Active and non-Active IP nodes. By using a model of constant and variable processing, integrating the Active and IP architectures has lead to a clean and simple node design and implementation. Furthermore, mechanisms presented in this report, such as protected buffers, provide various safety constraints which aid in the integration. Finally, this report presents some preliminary performance results which, when combined with the above characteristics, suggest that the Active IP platform will be appealing to researchers, who wish to study application specific protocols for the Internet.”

Legedza, Ulana; Wetherall, David J. and Guttag, John, Improving The Performance of Distributed Applications Using Active Networks, IEEE Infocom, San Francisco, April 1998.

“An active network permits applications to inject customized programs into network nodes. This permits faster protocol innovation by making it easier to deploy new network protocols, even over the wide area. In this paper, we argue that the ability to introduce active protocols offers important opportunities for end-to-end performance improvements of distributed applications. We begin by describing several active protocols that provide novel network services and discussing the impact of the services on end-to-end application performance. We then discuss two active protocols that implement a previously studied service, reliable multicast. One protocol is optimized to support batch applications and the other interactive applications. Finally, we analyze the performance of these protocols relative to a baseline non-active protocol. The results clearly demonstrate that the introduction of active protocols tuned to the needs of specific applications can lead to significant performance improvements.”

Wetherall, David J.; Legedza, Ulana and Guttag, John, Introducing New Internet Services: Why and How, IEEE Network Magazine Special Issue on Active and Programmable Networks, July 1998.

“Active networks permit applications to inject programs into the nodes of local and, more importantly, wide area networks. This supports faster service innovation by making it easier to deploy new network services. In this paper, we discuss both the potential impact of active network services on applications and how such services can be built and deployed. We explore the impact by suggesting sample uses and arguing how such uses would improve application performance. We explore the design of active networks by presenting a novel architecture, ANTS, that adds extensibility at the network layer and allows for incremental deployment of active nodes within the Internet. In doing so, ANTS tackles the challenges of ensuring that the flexibility offered by active networks does not adversely impact performance or security. Finally, we demonstrate how a new network service may be expressed in ANTS.”

Network Working Group, Request for Comments: 2475, December 1998.

“This document defines an architecture for implementing scalable service differentiation in the Internet. This architecture achieves scalability by aggregating traffic classification state which is conveyed by means of IP-layer packet marking using the DS field [DSFIELD]. Packets are classified and marked to receive a particular per-hop forwarding behavior on nodes along their path. Sophisticated classification, marking, policing, and shaping operations need only be implemented at network boundaries or hosts. Network resources are allocated to traffic streams by service provisioning policies which govern how traffic is marked and conditioned upon entry to a differentiated services-capable network, and how that traffic is forwarded within that network. A wide variety of services can be implemented on top of these building blocks.

“The differentiated services architecture specified in this document can be contrasted with other existing models of service differentiation. We classify these alternative models into the following categories: relative priority marking, service marking, label switching, Integrated Services/RSVP, and static per-hop classification. Examples of the relative priority marking model include IPv4 Precedence marking as defined in [RFC791 <http://www.faqs.org/rfcs/rfc791.html>], 802.5 Token Ring priority [TR], and the default interpretation of 802.1p traffic classes [802.1p]. In this model the application, host, or proxy node selects a relative priority or “precedence” for a packet (e.g., delay or discard priority), and the network nodes along the transit path apply the appropriate priority forwarding behavior corresponding to the priority value within the packet's header. Our architecture can be considered as a refinement to this model, since we more clearly specify the role and importance of boundary nodes and traffic conditioners, and since our per-hop behavior model permits more general forwarding behaviors than relative delay or discard priority.

“An example of a service marking model is IPv4 TOS as defined in [RFC1349 <http://www.faqs.org/rfcs/rfc1349.html>]. In this example each packet is marked with a request for a “type of service”, which may include “minimize delay”, “maximize throughput”, “maximize reliability”, or “minimize cost”. Network nodes may select routing paths or forwarding behaviors which are suitably engineered to satisfy the service request. This model is subtly different from our architecture. Note that we do not describe the use of the DS field as an input to route selection. The TOS markings defined in [RFC1349 <http://www.faqs.org/rfcs/rfc1349.html>] are very generic and do not span the range of possible service semantics. Furthermore, the service request is associated with each individual packet, whereas some service semantics may depend on the aggregate forwarding behavior of a sequence of packets. The service marking model does not easily accommodate growth in the number and range of future services (since the codepoint space is small) and involves configuration of the “TOS→forwarding behavior” association in each core network node. Standardizing service markings implies standardizing service offerings, which is outside the scope of the IETF. Note that provisions are made in the allocation of the DS codepoint space to allow for locally significant codepoints which may be used by a provider to support service marking semantics [DSFIELD].

“Examples of the label switching (or virtual circuit) model include Frame Relay, ATM, and MPLS [FRELAY, ATM]. In this model path forwarding state and traffic management or QOS state is established for traffic streams on each hop along a network path. Traffic aggregates of varying granularity are associated with a label switched path at an ingress node, and packets/cells within each label switched path are marked with a forwarding label that is used to lookup the next-hop node, the per-hop forwarding behavior, and the replacement label at each hop. This model permits finer granularity resource allocation to traffic streams, since label values are not globally significant but are only significant on a single link; therefore resources can be reserved for the aggregate of packets/cells received on a link with a particular label, and the label switching semantics govern the next-hop selection, allowing a traffic stream to follow a specially engineered path through the network. This improved granularity comes at the cost of additional management and configuration requirements to establish and maintain the label switched paths. In addition, the amount of forwarding state maintained at each node scales in proportion to the number of edge nodes of the network in the best case (assuming multipoint-to-point label switched paths), and it scales in proportion with the square of the number of edge nodes in the worst case, when edge-edge label switched paths with provisioned resources are employed.

“The Integrated Services/RSVP model relies upon traditional datagram forwarding in the default case, but allows sources and receivers to exchange signaling messages which establish additional packet classification and forwarding state on each node along the path between them [RFC1633 <http://www.faqs.org/rfcs/rfc1633.html>, RSVP]. In the absence of state aggregation, the amount of state on each node scales in proportion to the number of concurrent reservations, which can be potentially large on high-speed links. This model also requires application support for the RSVP signaling protocol. Differentiated services mechanisms can be utilized to aggregate Integrated Services/RSVP state in the core of the network [Bernet].

“A variant of the Integrated Services/RSVP model eliminates the requirement for hop-by-hop signaling by utilizing only “static” classification and forwarding policies which are implemented in each node along a network path. These policies are updated on administrative timescales and not in response to the instantaneous mix of microflows active in the network. The state requirements for this variant are potentially worse than those encountered when RSVP is used, especially in backbone nodes, since the number of static policies that might be applicable at a node over time may be larger than the number of active sender-receiver sessions that might have installed reservation state on a node. Although the support of large numbers of classifier rules and forwarding policies may be computationally feasible, the management burden associated with installing and maintaining these rules on each node within a backbone network which might be traversed by a traffic stream is substantial.

“Although we contrast our architecture with these alternative models of service differentiation, it should be noted that links and nodes employing these techniques may be utilized to extend differentiated services behaviors and semantics across a layer-2 switched infrastructure (e.g., 802.1p LANs, Frame Relay/ATM backbones) interconnecting DS nodes, and in the case of MPLS may be used as an alternative intra-domain implementation technology. The constraints imposed by the use of a specific link-layer technology in particular regions of a DS domain (or in a network providing access to DS domains) may imply the differentiation of traffic on a coarser grain basis. Depending on the mapping of PHBs to different link-layer services and the way in which packets are scheduled over a restricted set of priority classes (or virtual circuits of different category and capacity), all or a subset of the PHBs in use may be supportable (or may be indistinguishable).”

Network Working Group, Internet Draft, Multiprotocol Label Switching Architecture, February 2000.

“This internet draft specifies the architecture for Multiprotocol Label Switching (MPLS).

“Packet headers contain considerably more information than is needed simply to choose the next hop. Choosing the next hop can therefore be thought of as the composition of two functions. The first function partitions the entire set of possible packets into a set of “Forwarding Equivalence Classes (FECs)”. The second maps each FEC to a next hop. Insofar as the forwarding decision is concerned, different packets which get mapped into the same FEC are indistinguishable. All packets which belong to a particular FEC and which travel from a particular node will follow the same path (or if certain kinds of multi-path routing are in use, they will all follow one of a set of paths associated with the FEC). Rosen, Viswanathan & Callon [Page 4] Internet Draft draft-ietf-mpls-arch-06.txt August 1999.

“In conventional IP forwarding, a particular router will typically consider two packets to be in the same FEC if there is some address prefix X in that router's routing tables such that X is the “longest match” for each packet is destination address. As tie packet traverses the network, each hop in turn reexamines the packet and assigns it to a FEC. In MPLS, the assignment of a particular packet to a particular FEC is done just once, as the packet enters the network. The FEC to which the packet is assigned is encoded as a short fixed length value known as a “label”. When a packet is forwarded to its next hop, the label is sent along with it; that is, the packets are “labeled” before they are forwarded. At subsequent hops, there is no further analysis of the packets network layer header. Rather, the label is used as an index into a table which specifies the next hop, and a new label. The old label is replaced with the new label, and the packet is forwarded to its next hop.

The following summarizes the known mechanisms for transporting IP packets over an ATM network. These include: Classical IP, LANE, MPOA and MPLS

Classical IP Over ATM (CIP) allows existing users of IP to migrate to using ATM as the underlying data transport technology while still using existing applications designed for legacy IP systems. For this reason, ATM networks are partitioned into Logical IP Subnets (LIS) that communicate with each other via routers.

LANE operates at the MAC layer and can be used with any layer 3 protocol. In contrast, Classical IP over ATM only works with IP.

The ATM Forum has defined Multi-protocol over ATM (MPOA) to overcome one major shortcoming of LANE and CIP: these protocols require that hosts on different subnets (ELAN or LIS) communicate via intermediate routers, which significantly slows packet throughput because each router has to reassemble cells of the layer 3 packets for routing and segment the packet into cells again for forwarding. MPOA allows clients in different subnets to establish direct VCCs, also known as shortcuts, between each other and forward packets directly at layer 3, without any intermediate reassembly and segmentation. Within a subnet, MPOA uses LANE.

MPOA provides for a distributed, virtual router. The edge devices that connect the ATM subnets to legacy LAN segments are somewhat like interface cards for the virtual router. The entire ATM network connecting the edge devices is the virtual router forwarding backplane. The packet forwarding function is separated from the route calculation function, which is performed by the route server.

In the MPLS model, each router is also a switch. Packets that have been assigned to a shortcut carry fixed length labels, in addition to the usual layer 3 header. MPLS allows shortcuts to be set up based on a number of criteria such as destination IP addresses, classes of service and service policies, allowing for a very flexible network engineering. MPLS is not tied to ATM; instead, it aims to operate over any link layer technology that can support fixed length labels to identify shortcuts.

The fractured intelligence of today's packet networks present fundamental limitations to the deployment of large-scale carrier networks that provision next generation services demanding high bandwidth and/or real-time transmission. The lack of overall coordination across overlaying networks and among services remains a central shortcoming. The fundamental problems include:

1. Limitation of ability to provide service efficiently to large scale customer base

2. Limitation of ability to provide advanced service monitoring capabilities

3. Increase cost and complexity of equipment throughout network

4. Overburdening of network equipment CPUs with service, policy, traffic engineering, routing and switching execution

5. Such overburdening of network equipment deteriorates QOS, debilitating provisioning of QOS sensitive traffic.

With current practices, Intranet architectures can offer either guaranteed Quality of Service (QOS), Internet Protocol (IP) service management or flexibility in adapting new applications. Nevertheless, current procedures fail to deliver all three of these goals in an integrated solution. Providing the highest Quality of Service requires the emulation of circuit-switched networking whereby resource reservation occurs before transmission of request. However, technologies such as Asynchronous Transfer Mode (ATM) fail to deliver IP's range of service as it cannot natively route or match IP's addressing structure to its own. Furthermore, active networks enable the dynamic reconfiguration of network elements, adapting the network to the goals of specific applications. Nevertheless, though active networks offer advantages on a packet-by-packet basis, it cannot determine the overall network resource demands on the Intranet.

Current practices in IP networking provide a structure that coarsely differentiates packet flows through a best-effort system. The Common Open Policy Service (COPS) provides a client/server structure between a policy manager and network elements. This structure enables the mapping of application-desired Integrated Services (IntServ) policy requests in the Access Layer with Differentiated Services (DiffServ) settings in the Core. The fundamental design of this architecture fails to ensure end-to-end QOS. Hosts transmit on a best effort basis with policy decisions occurring with processing at the edge router (ER).

Current practices in ATM networking provide a structure that mediates IP transmissions inefficiently, sacrificing the end-to-end QoS of ATM transmission. In IP routing, each router a packet traverses assigns a packet to a Forward Equivalency Class. With Multiprotocol Label Switching MPLS), a packet gets assigned to an FEC only once-when it enters the network. The FEC is then encoded as a short fixed-length value termed a label, and that label is sent along with the packet at each hop. When the packet gets to the next node in its path, the label is used as an index to a lookup table at the node, which then provides a new label. The old label is switched for the new one, and the packet is forwarded. Through the mapping of MPLS labels to ATM VPI/VCIs, MPLS integrates a core functionality of IP routing with ATM switching. However, MPLS lacks the same capabilities as the IntServ/DiffServ architecture. Hosts transmit on a best effort basis with policy decisions occurring with processing at the Label Edge Router

### SUMMARY OF THE INVENTION

Rectification of these problems demand the development of an architecture that centralizes network intelligence, empowers hosts and modifies the activities of network elements. According to the invention, the following strategies can be utilized:

1. Gather information from a network about the availability of resources

2. Centralize data collection and policy/service management in databases at external service nodes

3. Provide intelligence in the form of software proxies to hosts so that they can communicate and respond to the external service nodes

4. Develop programs that make optimal decisions for the entire network based on information provided from hosts and provided in databases

5. Develop a service-policy signaling protocol that enables communication between service nodes, hosts and network elements to manipulate hosts and network elements based on the service nodes decisions

An object-oriented database can be developed to store fundamental network information. Objects can be matched to many variables including Management Information Bases (MIBs), host requests, IP multicasting addresses, IP and ATM addresses or service particular information. The database can utilize hierarchical addressing and routing tables to efficiently and time-effectively make optimal decisions. In the external service nodes, a service-policy program utilizing the information stored in these databases can make decisions concerning the optimal utilization of the network given host demands and network availability. Each host can be supplied with a software proxy that allows it to interact with the service node, allowing the hosts to inform the service node of the parameters of any transmission it requests. Communication between hosts, service nodes and network elements will be provided by a service-policy signaling protocol that will enable integrated signaling intelligence across a packet-network.

This architecture allows for the placement of increased intelligence at the host and service interface the decisions of the service-policy program with those above-mentioned protocols. Moreover, this architecture enables the seamless and effective large-scale monitoring of services provisioned. Tracking of time and types of services used can be implemented, allowing for intelligent selection and distribution of future services.

This architecture enables a wide variety of practical innovations in delivery of services to customers. Let us take a few general examples of areas where customers can be better served. A customer requests a web page. The software proxy installed in the host's computer uses the signaling protocol to send a message to the service node notifying the server of the relevant information to access the web page. The program in the service node reads the database and executes a decision on the availability of resources to access such a web page. The service node can decide that resources are unavailable, that resources can be made available through manipulating network elements or that resources are available. If it decides that resources are strictly unavailable, it can send the equivalent of a busy signal. However, if resources can be made available through manipulating network elements, it implements a decision and utilizes the signaling protocol to interface with the necessary network elements. In this manner, routers, switches, routing protocols, transport protocols, etc. can be manipulated to allow the necessary resources for this request. As it is accomplishing this, it can signal the web page that a customer seeks to view its content. The service node can, therefore,.react to the demands of the hosts.

Moreover, the service node can proactively respond to potential problems in the network through the decision-making capabilities of the service-policy program. Through the signaling protocol, the decisions of the program can manipulate host transmission and network activities. For instance, the program can decide that hosts must back off transmission of certain classes of service to relieve congestion in the network. The software proxy in the host would execute such requests. Similarly, the service-policy program can decide that network elements must drop, back off or execute different traffic engineering policies. Traffic engineering can be intelligently and centrally determined in service nodes and executed as needed throughout the appropriate places in the network.

The delivery of video services can be greatly advanced through the utilization of this architecture. As video transmissions are both real-time and high bandwidth, it is very difficult to deliver them on a large scale and with high QOS. This architecture will advance the service management features and vastly improve the policy/traffic engineering capabilities. Deploying a large number of IP multicasts over a large geographical area is imperative for those who seek to deliver ‘Cable TV’ over a packet environment. Managing the IP multicasts, the digital ad-insertion, and tracking user requests is a formidable challenge. This architecture will carry requesting information from hosts, store it in centralized databases and allow the service-policy program to execute decisions pertinent to transportation, records and billing. It will be able to track IGMP joins and leaves, enabling efficient and comprehensive service and policy management This allows providers to decide intelligently whether transmission of videos is more effective point-to-point or as a multicast based on the situation of the entire network.. Moreover, as host requests for these services are tracked constantly, the popularity of programming including content and advertising is available for comprehensive review. This enables a provider to optimize both the resources in their network and the programming offered to their customers.

### BRIEF DESCRIPTION OF THE DRAWINGS

FIG. 1 is a simplified flow chart showing host-local node interaction according to the invention;

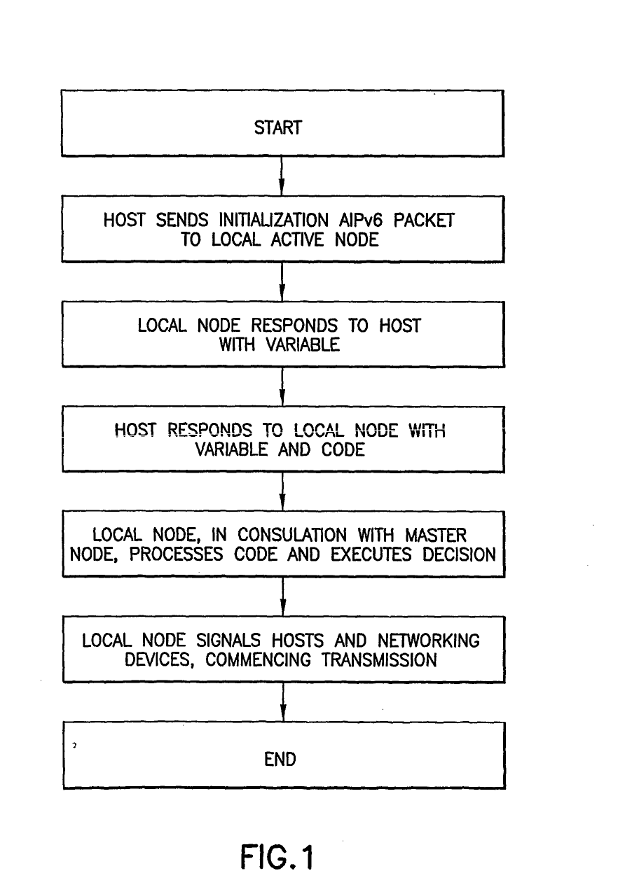

FIG. 2 is a simplified flow chart showing local node-master node interaction according to the invention;

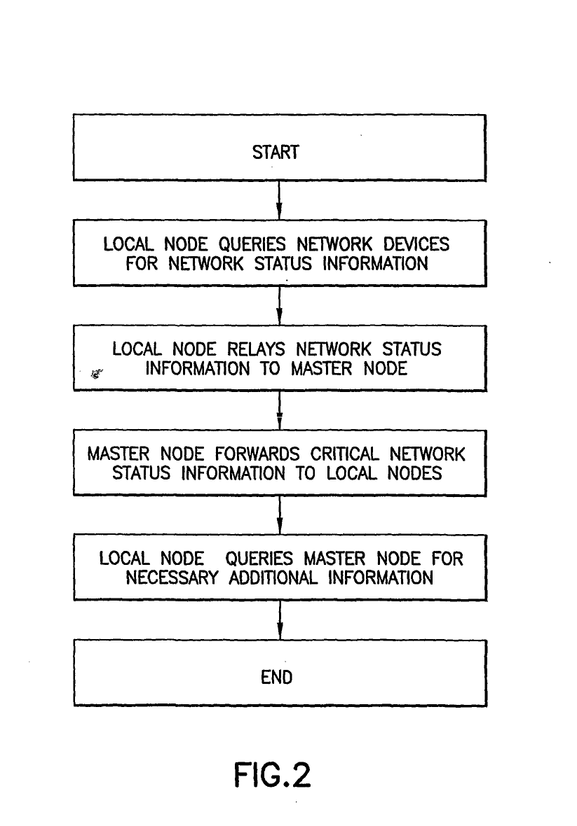

FIG. 3 is a simplified flow chart showing local node-networking equipment interaction according to the invention;

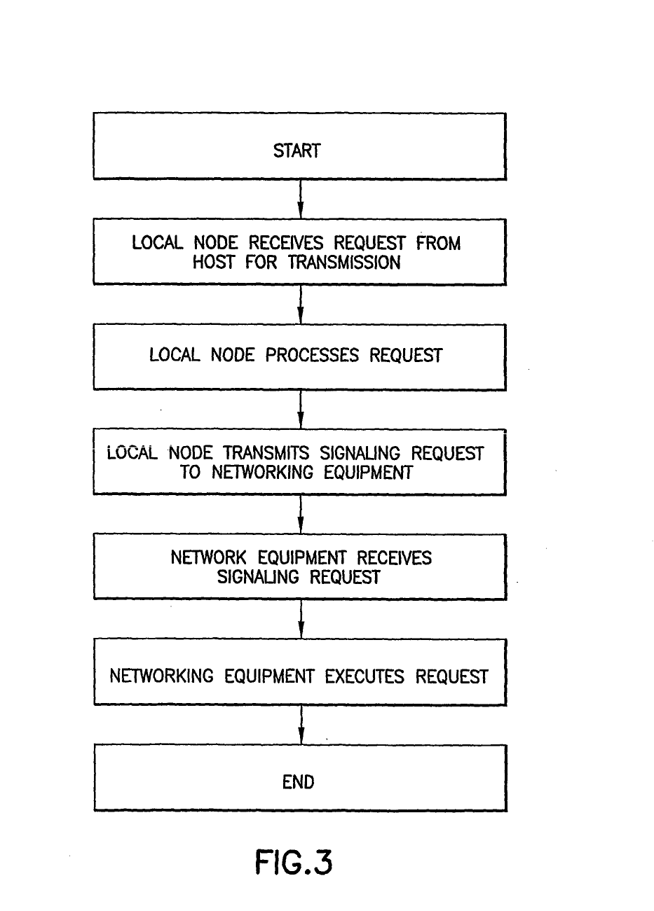

FIG. 4 is a simplified flow chart showing public internet web server architecture according to the invention; and

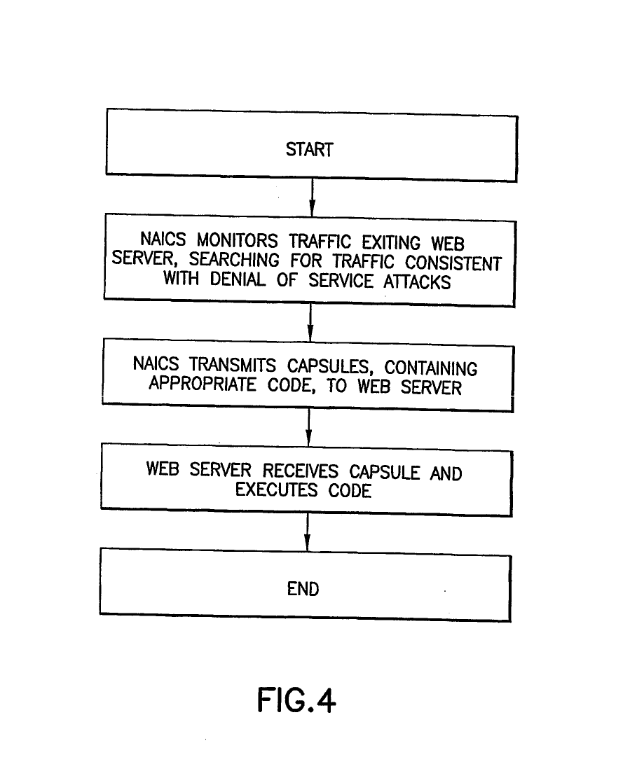

FIG. 5 is a simplified diagram illustrating the relationships among host, local node, master node, and networking equipment according to the invention.

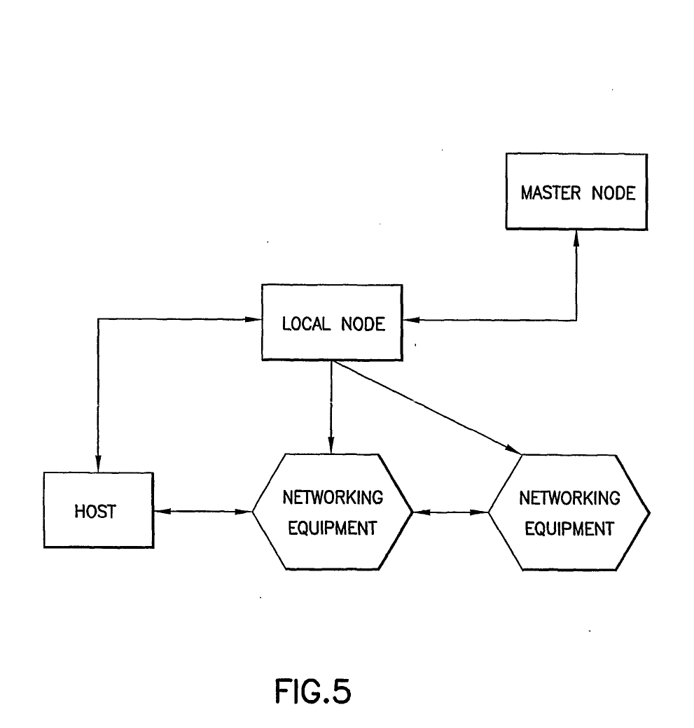

### DETAILED DESCRIPTION OF THE PREFERRED EMBODIMENTS

The Network Active Intelligence Control System (NAICS) according to the invention provides a hierarchical management structure for Intranets encompassing the utilization of a software proxy in hosts and two levels of active nodes coordinating the execution of policy and management services. A signaling protocol, AlPv6, developed for the interaction of active nodes, provides communication among the hosts and the active nodes. AIPv6 is a simple query and response protocol that can be used to exchange policy and service information between an active node and its clients. AIPv6 uses options, which were designed to support pre-defined optional processing, to support dynamically defined optional processing. The dual layer structure of active nodes serves two roles. First, utilizing AlPv6 to query and respond between the hosts, local nodes and master nodes, policy and service decisions can be distributed throughout the network. Secondly, this structure enables the distribution of network utilization statistics, collected as a basis for service and policy decisions. The architecture segments this role into local active nodes and master active nodes. Local active nodes collect SNMP polling information in a defined area whereas Master active nodes aggregate the polling information of the local active nodes in its areas. Master active nodes forward critical information to the local nodes and reply to the requests of local nodes for additional information, as necessary. Local nodes execute policy decisions through the transmission of SNMP ‘gets’ that reconfigure networking devices.

The NAICS architecture enables host themselves to signal Local Active Nodes with AIPv6 queries. Local Active Node responses provide a definitive answer to the queries of Hosts, securing the service and transmission parameters relative to service level agreements and network utilization. Service and transmission parameters, mediated by the active nodes, are secured throughout the entire Intranet.

Current practices in active nodes provide distributed intelligence for hosts and networking devices yet does not provide a structure for top-down policy and service management of Intranets. With active nodes, applications specify the routines to be executed instead of IP forwarding at the active network nodes that forward their messages. Applications distribute a portion of their processing into the network. The current practice in active networking utilize an architecture in which networking devices share the responsibility for both AIPv6 processing and transmission. The NAICS architecture segments these responsibilities, transferring the responsibility for policy and service management to a segregated structure of Local and Master active nodes. Networking devices within the Intranet transmit packets based on the SNMP signaling of the Local active nodes.

The Advantages of NAICS in a DSL/WAN Network

The current practice of Digital Subscriber Line (DSL)/Wide Area Network (WAN) networking is the provision of CPE modem/router devices, DSL Access Multiplexers, a number of management devices, Layer ⅔ Aggregators and Core ATM switches. This structure connects end-user's computers to a Wide Area Network interconnecting end-users and providing access to the Public Internet. However, service and policy management responsibilities lack centralized control as they are executed in diverse devices.

End-users forward traffic to their connected CPE modem/routers that transmit packets across the copper local loop to a DSL Access Multiplexer. Provision of network resources cannot be accomplished dynamically. That is to say, the requests of end-users cannot immediately reconfigure the network devices in line with said request. Transmissions must adhere to the pre-defined parameters. Transmission that do not do conform are penalized with potential drop or delay of the delivery. Notification of end-users occurs only with the reliance of transport layer protocols such as Transmission Control Protocol. End-users lack a comprehensive mechanism to determine service or transmission status.

With current practices, service management is accomplished through a number of diversely controlled devices. Remote Access Dial In User Service (RADIUS) servers provide Authentication, Authorization and Accounting (AAA) services critical to the deployment of DSL services as they track user, technical and business management capabilities. Domain Name Servers (DNS) provides a lookup service that retrieves information associated with domain names. DNS services are critical to simple and effective Internet access. Dynamic Host Configuration Protocol (DHCP) enables a server to dynamically assign IP addresses to end-users. DNS and DHCP are commonly integrated into one networking device. Service Connection Management mechanisms provision connections to DSL end-users, relate subscribers to DSL services, view SNMP traps and access the fault, configuration, accounting, performance, security (FCAPS) functionality. A number of distinct devices not optimized for interaction and cohesive service execution characterize current practices.

The best current mechanism for policy management of DSL/WAN networks is the execution of the Common Open Policy Service (COPS) mechanism. COPS provide a client/server structure between a policy manager and network elements. From the edge of a network, best-effort policies can be enacted based on a centralized policy server. However, this architecture provides signaling between edge routers and a policy server. No signaling exists between the hosts of a DSL network and centralized servers. The multiple devices that provide service management cannot be integrated into this policy management structure. Moreover, all of the techniques in current practices for DSL services cannot dynamically adapt to the demands of new and diverse applications.

A service provider seeks to authenticate and allocate resources for particular applications on demand to its DSL/WAN subscribers. Currently, the best practice is that the networking devices allow subscribers to signal a service management server that authorizes and accounts the provision of a value-added service. A subscriber would utilize a GUI to request such a service, query and respond with the service management server, and receive authorization for that service. The server could signal the delivery of certain application. The server could not establish the policy requirements with the requesting host. In the current practice, such decisions occur at the edge of a network.

In the Network Active Intelligence Control System (NAICS), execution of networking requests utilizes a pre-determined yet dynamically adaptable mechanism In the current practice, hosts transmit on a best effort basis and receive AAA through servers distinct from policy and transmission functionalities. NAICS utilizes software proxies in host computers. These software proxies contain databases that map application types to transmission and service parameters. Requested applications match code representing transmission and service parameters. These parameters can signal the control system to the service and policy needs of that specific host Hosts transmit an Advanced Internet Protocol Version 6 packet (AMPv6) to a Local active node. The Local Active Node responds to the Host with a variable, stored in the local node's soft-cache, that maps to the sender's IP address. The Host responds to that transmission of the Local Active Node with the variable assigned by the node and the code representing the transmission and service parameters needed for the application. The Local Active Node stores the variable, source and destination IP address in a table. An interpreter executes a decision based on the contents of the table. The database in the Local Active Node stores critical information to the execution of service and policy decisions including SNMP network utilization, IP routing table, Private Network-Network Interface (PNNI) routing table, Internet Group Management Protocol (IGMP), Value-Added Applications, AAA, DNS and DHCP. The Local Active Node relays the decision to the Host through transmitting code contained in an AIPv6 packet to the Host. Based on the decision executed, the Local Active Node utilizes SNMP ‘gets’ to reconfigure networking devices. The transmission of SNMP ‘gets’ facilitates the provision of requests for specific transmission and service parameters for the host

The query and response mechanism of AIPv6 between hosts and Local Active Nodes simplifies the current practice of interaction between the hosts and various service management devices and rectifies the lack of interaction between hosts and policy management devices.

AIPv6 query and response enables Local Active Nodes and Master Active Nodes to synchronize network utilization information in a scalable manner. Through SNMP, Local Active Nodes poll network devices to determine current network utilization. Given a limited amount of devices and hosts, one Local Active Node is sufficient for polling of network utilization information and to respond to requests from end-users. In a large-scale network, such as a DSL/WAN, multiple Local Active Nodes are necessary to execute this responsibility and a higher-level device is needed to synchronize the activities of the Local Active Nodes. The Master Active Node responds to queries of the Local Active Nodes to ensure such synchronization. At regular intervals, the Master Node receives AIPv6 packets from the Local Active Nodes. At regular intervals, the Master Node transmits AIPv6 packets containing critical network utilization information forwarded from other Local Active Nodes. Upon AIPv6 signaling query from a Local Active Node requesting additional network information, the Master Node responds with an AIPv6 packet providing the necessary information.

This practices enables the direct communication of hosts to a service/policy management platforms that registers network utilization, transmission and service parameters to centrally execute host requests. In contrast to the current practices of separate structures for different platforms and functionalities, all service management and policy capabilities are executed in a singular platform. DSL customers in such a solution utilize a software proxy that maintains a database, enabling AIPv6 signaling to the Local-Master Control System that matches requested parameters with service level authority and network capability, thereby overcoming the best-effort, edge-based, diverse platform service management structure of the current practice.

NAICS Web Server Architecture

NAICS strategy provides the determination of dynamic policy rather than the current practice of statically applied, administratively determined firewalls. NAICS enables constant monitoring, immediate response and a dynamic policy implementation that ensures the filtering of malicious traffic while allowing open access of the Internet community to the web server. The fundamental NAICS-Web Server architecture entails three components. The first component is an edge router connecting a Web Server(s) to a Wide Area Network (WAN), Local Area Network (LAN) or public Internet. The router interfaces with a NAICS Active Node Security Platform that mediates transmission between the router and the Web Server. The final component of this architecture is a Web Server enabled as an active node.

Routers forward client's request to the NAICS Active Node Security Platform. The NAICS passively forwards incoming transmissions (i.e., transmissions from the network, through the router, and destined for the Web Server) unless those packets are AIPv6 enabled. AIPv6 packets are processed, the contained code is read and necessary decisions are executed. All other packets are transparently forwarded to the active node enabled Web Server. For these packets, the Web Server executes decisions in a manner consistent with current practices. However, packets transmitted from the Web Server are encapsulated in AMPv6 packets. In a mediation role, the NAICS platform processes each AlPv6 packet transmitted from the Web Server towards the router. The NAICS platform contains tables enabling it to read the AIPv6 packets and record the contents of the packet in appropriate tables. This monitoring functionality is consistent with and builds from the basic capability of an active node. Based on algorithms determined to monitor for activities consistent with distributed denial of services attacks, the NAICS platform records packets transmitted from the web server and matches tables detailing the records of these packets with said algorithms. The algorithms can execute predetermined scripts that manipulate networking devices. The NAICS platform utilizes two mechanisms to adapt networking devices to rectify effects debilitating network performance. Utilizing an interface to Telnet scripts, the NAICS platform reconfigures the access list of the router accepting traffic to the Web Server. In this same manner, the NAICS platform executes script that engenders the performance of a traceroute command, determining the source of the attack. Utilizing the same mechanism to reconfigure access lists, the NAICS platform can reconfigure the access list to include the address range of the entire router originating the attack. This mechanism rectifies an attacker's attempt to dynamically utilize new IP addresses through the blocking of the entire range of addresses originating the attack. The second mechanism enables the NAICS platform to utilize AlPv6 packets to reconfigure the active node enabled Web Server. The NAICS platform chooses code consistent with a script called from a services attack. The AIPv6 packet delivers the code that reconfigures the Web Server to manipulate network parameters to block IP addresses and TCP/UDP ports responsible for distributed denial of service attacks.

In this architecture, active node functionality can be provided to end-users. A component in the web server enables hosts to download an active node software proxy that optimizes transmission between hosts and a web server. Incoming transmissions from the router through the NAICS platform to the Web Server are processed and optimized by the NAICS platform. The Hosts transmits AIPv6 packets to the Web Server. These packets will be processed by the NAICS platform mediating traffic between the network and the Web Server. The NAICS platform reads the contained code in the AlPv6 platform and processes the packet accordingly.

There have been described and illustrated herein several embodiments of methods and apparatus for controlling internet protocol traffic in a WAN or LAN. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as so claimed.

1. An apparatus for controlling traffic in a communications network, comprising:
a) a master active node coupled to the network; and
b) a plurality of local active nodes coupled to the network, each of said local active nodes having
i) means for polling network devices to determine current network utilization,
ii) means for sending a query to said master active node, and
iii) means for receiving a response from said master active node, wherein one of said local active nodes sends a query to said master active node requesting information about network devices polled by another local active node.

2. An apparatus according to claim 1, wherein:
each of said local active nodes has means for transmitting information about network devices polled by it to said master active node, and
said master active node has means for periodically transmitting network utilization information to said local active nodes.

3. An apparatus according to claim 2, wherein:
said local active nodes poll network devices via SNMP, and
said local active nodes communicate with said master active node via AIP.

4. An apparatus according to claim 1, further comprising:
c) a plurality of hosts associated with each local active node, each host having means for sending a query to the local active node to which it is associated.

5. An apparatus according to claim 4, wherein:
said local active nodes each have means for responding to queries from hosts associated with it.

6. A method for controlling traffic in a communications network, comprising:
a) associating groups of network devices with local active nodes;
b) polling network devices from the local active node associated with them; and
c) transmitting information about network device utilization from the local active nodes to a master active node.

7. A method according to claim 6, further comprising
d) sending a query from one local active node to the master active node requesting information about network devices polled by another local active node.

8. A method according to claim 6, further comprising
d) periodically transmitting network utilization information to said local active nodes from the master active node.

9. A method according to claim 6, wherein:
the local active nodes poll network devices via SNMP, and
the local active nodes transmit to the master active node via AIP.

10. A method according to claim 6, further comprising:
d) associating a plurality of hosts with each local active node;
e) sending a network status query from a host to the local active node with which it is associated.

11. A method according to claim 10, further comprising:
f) responding to the host query from the local active node associated with the host.
